(19) United States
(12) Patent Application Publication
(10) Pub. No.: US 2017/0206621 A1
(43) Pub. Date: Jul. 20, 2017

(54) Systems and Methods for Determining the Effectiveness of Warehousing

(71) Applicant: Alibaba Group Holding Limited, Grand Cayman (KY)

(72) Inventors: Yu WANG, Hangzhou (CN); Rui WANG, Hangzhou (CN); Zhou YE, Hangzhou (CN); Jinming WANG, Hangzhou (CN); Xiaojun CHEN, Hangzhou (CN)

(21) Appl. No.: 15/403,351

(22) Filed: Jan. 11, 2017

(30) Foreign Application Priority Data
Jan. 14, 2016 (CN) 201610024345.X

(51) Int. Cl. G06Q 50/28; G06Q 10/06

(52) U.S. Cl. CPC G06Q 50/28; G06Q 10/06315; G06Q 10/0635; G06Q 10/06395

(57) ABSTRACT

Embodiments of the disclosure present systems and methods for determining the effectiveness of warehousing. In one embodiment, the method comprises receiving warehousing information, wherein the warehousing information comprises a location and an actual transport capacity of a warehousing control center and historic logistics information associated with the warehousing control center; calculating a demanded transport capacity of the warehousing control center based on the historic logistics information and the location of the warehousing control center; determining if the demanded transport capacity is equal to or less than the actual transport capacity; determining that the warehousing is effective upon the determination that the demanded transport capacity is equal to or less than the actual transport capacity; and determining that the warehousing is ineffective if the demanded transport capacity is greater than the actual transport capacity.

### CROSS-REFERENCE TO RELATED APPLICATIONS

This application claims the benefit of priority from Chinese Patent Application No. 201610024345.X, filed on Jan. 14, 2016 entitled, “A Method and System for Determination of Effectiveness of Warehousing,” which is incorporated herein by reference in its entirety.

### BACKGROUND

Field of the Disclosure

The present disclosure relates to the field of warehouse optimization, and particularly to systems and methods for determining the effectiveness of warehousing.

Description of the Related Art

Currently, in the field of electronic commerce (“e-commerce”), consumers are increasingly placing emphasis on the quality and experience of logistics. Oftentimes, the timeliness of logistics is the most important factor to consumers in making purchasing decisions. Accordingly, e-commerce providers are now required to focus on constructing logistics networks to support new, online properties (e.g., online supermarkets, direct procurement, etc.). For example, an online supermarket generally must commit to home delivery within 24 hours within covered regions, while direct procurement requires rapid home delivery due to a large number of orders for fresh products and time-limited products.

On the other hand, the ultimate goal of logistics is to integrate multiple platforms and construct a “super” logistics network in order to enable an e-commerce provider to perform nationwide deliveries within 24 hours. Currently, current logistics projects suffer from numerous deficiencies, especially with respect to home delivery within 24 hours (e.g., for an online supermarket).

First, for warehouses, although delivery capacity on roads between provinces and between cities can be determined, it is difficult for current solutions to maintain stock within a city that satisfies the demand of that city.

Second, in order to guarantee the logistics experience customers expect, a warehouse site must be selected within a city that can guarantee timeliness (e.g., delivery within 24 hours) and delivery time frames (e.g., delivery in early morning is prohibited). In order to make these guarantees, the current strategy of e-commerce platforms is to simply construct as many warehouses as possible.

Third, for distribution within a city (especially in a city with severe traffic congestion), delays of package deliveries are primary caused by traffic conditions within the city (e.g., traffic jams, traffic accidents, etc.). Using current techniques, couriers cannot instantaneously get comprehensive knowledge of traffic conditions and packages on the day of delivery and are forced to follow the same routes for delivery due to this lack of knowledge.

To date, little attention has been paid to these issues since these deficiencies have not been set forth by industry participants. In academia, scientific researchers generally cannot access actual logistics details and warehouse data, which directly impedes the development of scholarly research. Despite these restrictions, there have been limited, partial solutions for logistics management, logistics monitoring, and logistics warehousing with respect to products and industrial solutions. However, these solutions cannot solve the issues mentioned above because customer experiences such as logistics speed, quality etc., do not draw sufficient attention.

### BRIEF SUMMARY

In view of the issues mentioned above, systems and methods for determining effectiveness of warehousing are disclosed herein that overcome these deficiencies. In general, the disclosure describes systems and methods that utilize data processing techniques to calculate the efficiency of warehousing by detecting or predicting when warehousing will fail in view of demands placed on the warehousing (e.g., an increased demand for products).

In one embodiment the method comprises receiving warehousing information, wherein the warehousing information comprises a location and an actual transport capacity of a warehousing control center and historic logistics information associated with the warehousing control center; calculating a demanded transport capacity of the warehousing control center based on the historic logistics information and the location of the warehousing control center; determining if the demanded transport capacity is equal to or less than the actual transport capacity; determining that the warehousing is effective upon the determination that the demanded transport capacity is equal to or less than the actual transport capacity; and determining that the warehousing is ineffective if the demanded transport capacity is greater than the actual transport capacity.

In another embodiment the system comprises a warehousing information receiving module for receiving warehousing information, wherein the warehousing information comprises a location and an actual transport capacity of a warehousing control center and historic logistics information associated with the warehousing control center; a demanded transport capacity determination module for calculating a demanded transport capacity of the warehousing control center based on the historic logistics information and the location of the warehousing control center; a demanded transport capacity judgment module for determining if the demanded transport capacity is equal to or less than the actual transport capacity; and a warehousing effectiveness determination module for determining that the warehousing is effective upon the determination that the demanded transport capacity is equal to or less than the actual transport capacity.

The disclosed embodiments provide the following advantages.

In one embodiment, warehousing information is received first, and the demanded transport capacity for an existing warehouse is determined according to historic logistics information contained within the warehousing information. Next, the actual transport capacity and the demanded transport capacity are compared to determine if the current warehousing satisfy the demanded transport capacity. If it is satisfied, the current warehousing is determined to be effective.

Considering the growing popularity of online shopping, the number of waybills is increasing and current techniques for warehousing will eventually be unable to satisfy the demanded transport capacity. Therefore, even when current warehousing is determined to be effective, a failure point of the current warehousing (e.g., a point in time when warehousing will be ineffective) may be calculated, so that the warehousing can improved in light of the predicted failure point.

### BRIEF DESCRIPTION OF THE DRAWINGS

FIG. 1 is a flow diagram illustrating a method for determining effectiveness of warehousing according to some embodiments of the disclosure.

FIG. 2 is a flow diagram illustrating a method for determining effectiveness of warehousing according to some embodiments of the disclosure.

FIG. 3 is a diagram of a categorical classification of merchandise according to some embodiments of the disclosure.

FIG. 4 is a block diagram of a system for determining effectiveness of warehousing according to some embodiments of the disclosure.

FIG. 5 is a block diagram of a system for determining effectiveness of warehousing according to some embodiments of the disclosure.

### DETAILED DESCRIPTION

To provide a clearer understanding of objectives, features, and advantages of the present disclosure, the embodiments mentioned above are described in more detail with respect to the Figures and associated descriptions below.

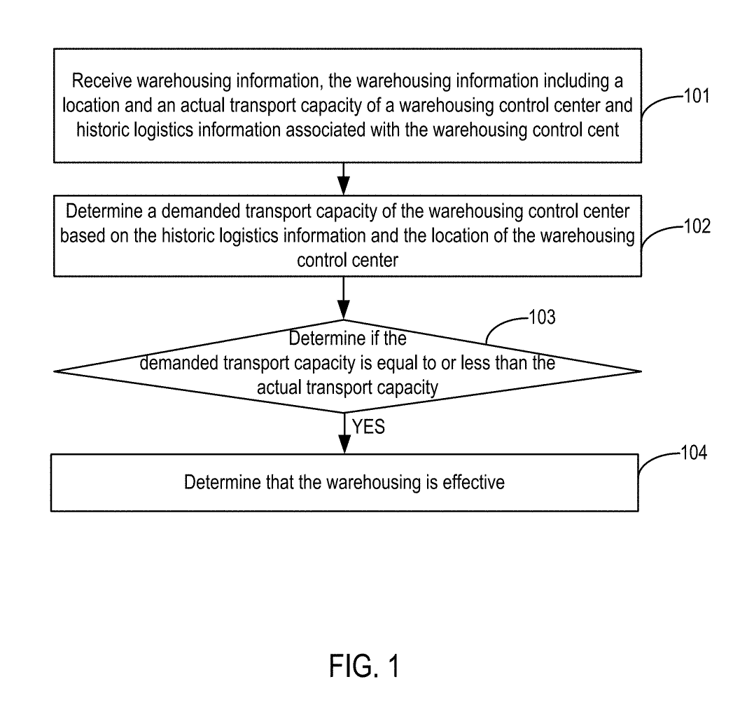

FIG. 1 is a flow diagram illustrating a method for determining effectiveness of warehousing according to some embodiments of the disclosure.

In step 101, the method receives warehousing information. In one embodiment, warehousing information includes the location and actual transport capacity of a warehousing control center present within a warehouse. Alternatively, or in conjunction with the foregoing, warehousing information may additionally include historic logistics information associated with the warehousing control center.

In one embodiment, one or more warehousing control centers may be deployed within a country, province, or city as needed. Distributions of distribution targets will be described in terms of buyers in regions covered by the warehousing control centers. In one embodiment, a distribution target in the field of e-commerce may comprise merchandise to be distributed.

In one embodiment, warehousing may also be referred to as a “logistics solution.” In alternative embodiments, warehousing may be associated with one or more warehousing control centers, locations of those warehousing control centers, and an actual transport capacity for each warehousing control center. In order to guarantee transport quality and transport experience for logistics of distribution targets, the actual transport capacity of current warehousing capable of satisfying the demanded transport capacity has to be guaranteed. Thus, warehousing information may be collected in step 101 to determine effectiveness of the warehousing.

In some embodiments, the method described in connection with FIG. 1 may be applicable to the field of e-commerce, especially to an online retailer for which distribution times need to be guaranteed within a designated time frame (e.g., an online supermarket).

In step 102, a demanded transport capacity of the warehousing control center is determined based on the historic logistics information and the location of the warehousing control center. In one embodiment, step 102 may include the following substeps.

In substep S11, the method extracts historic logistics information for a designated period of time in the past from the historic logistics information.

In substep S12, the method calculates the demanded transport capacity of the warehousing control center based on the extracted historic logistics information and the location of the warehousing control center.

In one embodiment, the transport capacity of the warehousing control center may be reflected by using logistics vehicles (for regions) and distribution vehicles (for areas in regions). It may be understood that logistics vehicles and distribution vehicles can, respectively, transport a certain, limited number of packages.

In one embodiment, the logistics information may be received from a logistics database of an e-commerce platform, and deployment locations of various warehousing control centers may be combined with geographic information to calculate a package volume from daily historic logistics information in the past one month, in order to calculate demanded transport quantity of the logistics vehicles or the distribution vehicles on the basis of the package volume.

In step 103, the method determines whether the demanded transport capacity is equal to or smaller than the actual transport capacity.

In step 104, the warehousing (and thus, the warehousing control center) is determined to be effective if the method determines that the demanded transport capacity is equal to or less than the actual transport capacity in step 103.

Specifically, if the quantity of logistics vehicles or distribution vehicles required to meet the demanded transport capacity is equal to or smaller than the actual quantity of the logistics vehicles or the distribution vehicles of the warehousing control center, it indicates that the current warehousing may satisfy the demanded transport capacity, that is, the current warehousing may be regarded as effective.

In one embodiment, the method may further comprise determining that the warehousing is ineffective if the demanded transport capacity is greater than the actual transport capacity.

If the quantity of the logistics vehicles and the distribution vehicles associated with the demanded transport capacity is greater than the actual quantity of the logistics vehicles and the distribution vehicles of the warehousing control center, it indicates that the current warehousing is already unable to satisfy the demanded transport capacity, that is, the current warehousing may be regarded as ineffective.

In one embodiment, the method may further comprise the steps of receiving a past package volume and distribution times associated with packages in a past package volume for a preset distribution time, the preset distribution time representing a period of time in the past; forecasting a future package volume based on the distribution times; and calculating a distribution coverage based on the future package volume and an area package volume.

In one embodiment, the distribution coverage (i.e., 24-hour delivery rate of merchandise) of current warehousing may be further evaluated. For e-commerce with strict requirements on arrival time of merchandises, such as an online supermarket, the distribution coverage is paramount.

Specifically, the deployment locations of warehousing may be combined with geographic information to determine a total package volume, as well as the distribution time associated with each of package volumes statistically with the daily historic logistics information in the past month. In one embodiment, the distribution time comprises the start time of distribution and end time of distribution. The time required for distribution of the package may be calculated according to the start time of distribution and the end time of distribution. A package may be assigned with value of 1 to indicate successful distribution if the required time is less than 24 hours. On the contrary, a package may be assigned with value 0 to indicate failed distribution if the required time is more than 24 hours. The binary marking of packages as successfully being distributed or failing to be distributed discussed above is only an example. In practice, other approaches may be used to indicate whether the package is distributed successfully, and the embodiments disclosed herein are not limited thereto.

In one embodiment, the total package volume, as well as quantity of packages marked as failed distributions in the area in the past month may be statistically determined in order to calculate the distribution coverage of the month. According to the distribution coverage, the satisfaction rate of buyers may be roughly calculated, so that warehousing may be adjusted according to actual situations.

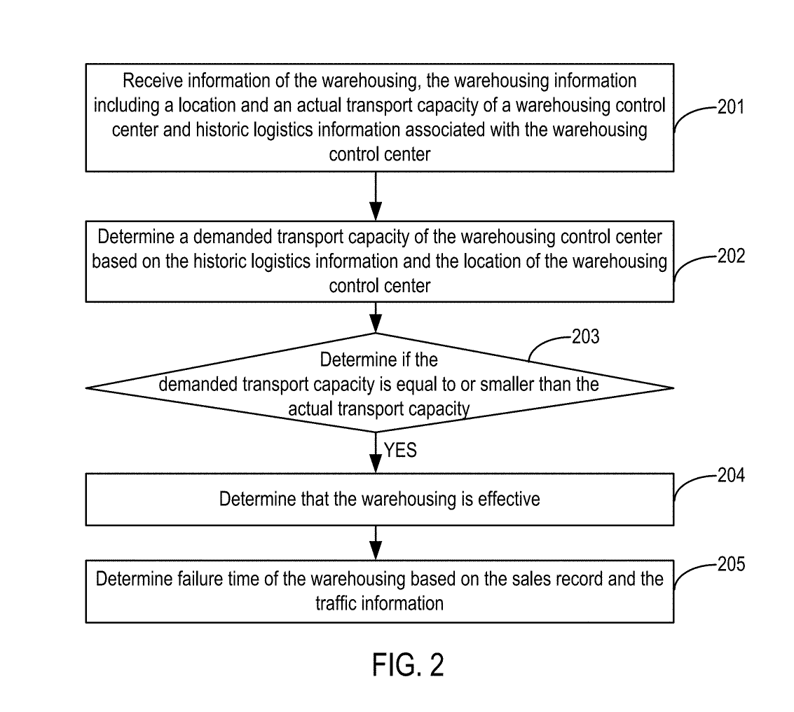

FIG. 2 is a flow diagram illustrating a method for determining effectiveness of warehousing according to some embodiments of the disclosure.

In step 201, warehousing information is received, wherein the warehousing information includes a location and an actual transport capacity of a warehousing control center in the warehousing, as well as historic logistics information associated with the warehousing control center. In some embodiments, the warehousing information further includes traffic information and sales record data of an e-commerce platform.

In step 202, a demanded transport capacity of the warehousing control center is calculated based on the historic logistics information and the location of the warehousing control center.

In step 203, the method determines if the demanded transport capacity is equal to or smaller than the actual transport capacity.

In step 204, the warehousing is determined to be effective if the demanded transport capacity is equal to or smaller than the actual transport capacity.

In step 205, a failure point of the warehousing is determined based on the sales records and traffic information.

In one embodiment, a current actual transport capacity may be capable of satisfying a demanded transport of the distribution targets, but the number of waybills may continue to increase with further popularity of online shopping over the Internet. Therefore, in the case where only the current actual transport capacity is satisfied without predicting future waybills, adjustment for future transport capacity may not be available, and merchandise may not be transported to associated users in a timely manner in the future. Thus, user experience will be reduced accordingly.

Thus, in one embodiment, the failure point of the current warehousing may be further determined, so that personnel can respond and adjust warehousing in time based on the determined failure point. As discussed previously, a “failure point” may comprise a point of time in the future where actual transport capacity is less than a future demanded transport capacity.

It should be noted that in some occasions (e.g., holidays, high-volume shopping days such as Singles Day, Double 12, Black Friday, and the like) an accelerated increase of short-term sales volume may appear. It may be understood that issues of insufficient transport may usually appear due to excessive order quantity on such occasions. Therefore, in practice, a failure point that is calculated in such situations should not be regarded as significant and may be ignored without regarding it as the failure point of the current warehousing.

In one embodiment, a sales record may include the time and volume of a sales target. In this embodiment, step 205 may comprise the following substeps.

In substep S21, the method may predict an overall future sales volume of the sales target at a designated time in the future based on the time and the volume of the sales target.

In substep S22, the method may calculate proportions of various industries and categories in a designated region with respect to a general category in the region.

In substep S23, the method may calculate a regional package volume at the designated time in the future based on the proportions and a preset regional logistics proportion based on the overall future sales volume.

In substep S24, the method may calculate a future demanded transport capacity of the warehousing based on the regional future package volume.

In substep S25, the method may determine if the future demanded transport capacity is greater than the actual transport capacity.

In substep S26, the method may determine a failure point based on the designated time in the future it is determined that the future demanded transport capacity will exceed the actual transport capacity.

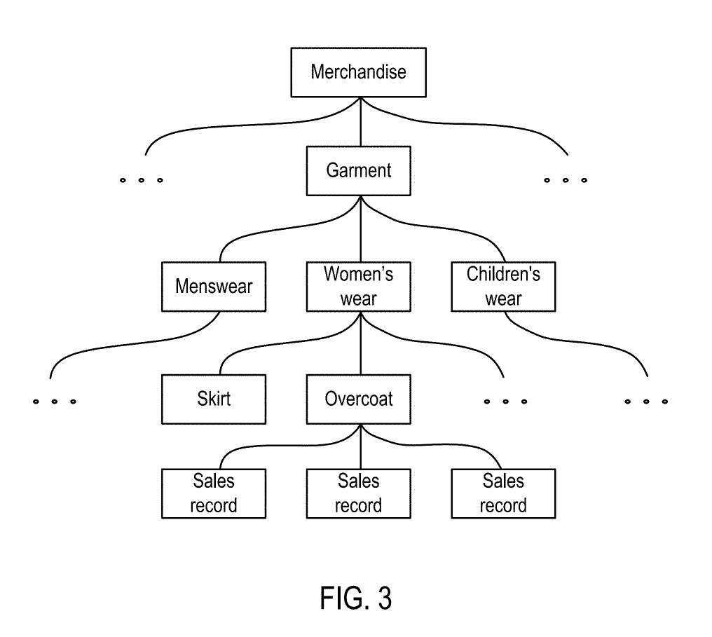

FIG. 3 is a diagram of a categorical classification of merchandise according to some embodiments of the disclosure.

In one embodiment, merchandise may be classified for differentiation in terms of certain industries and categories. For example, merchandise may be associated with the garment industry, under which there may exist menswear, women's wear, children's wear, etc. Under the menswear, women's wear and children's wear categories, further classification may be performed. In one embodiment, a database in the e-commerce platform may maintain the historic logistics information of the merchandise.

In one embodiment, for regions (city level), proportions of various industries and categories in each of the regions may be calculated to convert a sales volume of the merchandise into a package volume of the respective region. With the overall future sales volume received via prediction, a future package volume may be calculated according to the proportions of the industries and categories of the respective regions with respect to a general category, and the regional logistics proportions of the respective regions.

According to a package volume in a day, a demanded quantity for logistics vehicles in the future may be calculated. In comparing the demanded quantity and actual quantity for the logistics vehicles, effectiveness of the current warehousing may be learned. In case the demanded quantity for the logistics vehicles is greater than the actual quantity, the warehousing within that day is said to be ineffective, and a corresponding time node may be output as failure point.

Returning to FIG. 2, in one embodiment, the substep S21 may comprise the following substeps.

In substep S21-11, the method receives, for the designated time in the future, sales volumes of various industries and categories in the month prior to the corresponding lunar month in this year, as well as sales volumes of various industries and categories in the month prior to the corresponding lunar month in the last year.

In substep S21-12, the method calculates a ratio by comparing the sales volumes of various industries and categories in the month prior to the corresponding lunar month in this year and the sales volumes of various industries and categories in the month prior to the corresponding lunar month in the last year.

In substep S21-13, the method receives future sales volumes of various industries and categories at the designated time in the future with the ratio and the time corresponding to the designated time in the future in the last year.

In substep S21-14, the method acquires an overall future sales volume based on the future sales volumes of various industries and categories.

In one embodiment, considering that most Chinese festivals are recorded using the lunar calendar, such as Spring Festival, winter solstice and the like, the lunar calendar may be used for calculation directly when data with respect to date have to be used. In alternative embodiments, considering global application demand today, statutory festivals of various nations, calendars of various religions differ, the common Gregorian calendar in the world may also be used instead of the lunar calendar. The embodiments disclosed herein are not limited to a particular calendar. In combination with national conditions of China, the lunar calendar may be considered for use with higher priority.

Assuming that the overall future sales volume was calculated based on the lunar calendar, but a significant Gregorian calendar festival exists in the calculated period of time within the lunar calendar, switching from the lunar calendar to the Gregorian calendar for calculation may be performed. A significant Gregorian calendar festival may refer to a festival day capable of quickly increasing sales volumes of related merchandises within that day or near that day. For example, in the month within which Christmas exists, sales volumes of related merchandises, such as Christmas ornaments, rapidly increase. In one embodiment, if a significant Gregorian calendar festival exists in the lunar month associated with the designated time in the future in this year, then the substep S11 may comprise the following substeps.

In substep S21-21, the method receives, for the designated time in the future, sales volumes of various industries and categories in the month prior to the corresponding Gregorian calendar month in a year, as well as sales volumes of various industries and categories in the month prior to the corresponding Gregorian calendar month in the last year.

In substep S21-22, the method calculates a ratio by comparing the sales volumes of various industries and categories in the month prior to the corresponding Gregorian calendar month in this year and the sales volumes of various industries and categories in the month prior to the corresponding Gregorian calendar month in the last year.

In substep S21-23, the method receives future sales volumes of various industries and categories at the designated time in the future with the ratio and the time corresponding to the designated time in the future in the last year.

In substep S21-24, the method calculates an overall future sales volume based on the future sales volumes of various industries and categories.

It may be understood that the lunar calendar is used to record most Chinese festivals. However, the Gregorian calendar is also used for some festivals (e.g., National Day, Labour Day, Singles Day, Double 12, etc.), thus it is unreasonable to solely use the lunar calendar. Therefore, in one embodiment, the Gregorian calendar may still be used for exact calculation if, under calculation, a significant festival exists in the Gregorian calendar month associated with the lunar month. The approach using the Gregorian calendar for calculation is fundamentally the same as the approach using the lunar calendar for calculation.

It is to be noted that, in one embodiment, either the lunar calendar or the Gregorian calendar may be used individually. When using the lunar calendar, the Gregorian calendar may be used instead if a significant Gregorian calendar festival exists in a period of time within the lunar calendar. Alternatively, when using the Gregorian calendar, the lunar calendar may be used instead if a significant lunar calendar festival exists in a period of time within the Gregorian calendar. For countries or regions using different date recording approaches, corresponding date recording approaches are used. The embodiment of the present disclosure is not limited thereto.

In one embodiment, the method may further comprise receiving future sales volumes of various industries and categories for a preset future time period and calculating a short-term acceleration index based on the future sales volumes of various industries and categories and the median of the sequence of the sales volumes.

In practice, short-term quick increases of sales volume may appear for some merchandise in some months (e.g., the month containing the Mid-Autumn Festival in China) in which the sales volume of, for example, moon cakes will quickly increase. Hence, the sales volumes for merchandise with short-term acceleration may also be of interest. In one embodiment, to generate focus indices for key industries and categories with acceleration, the method may receive a short-term acceleration index by dividing the sales volume in the coming half month by the sales volume in the past one month or year. In order to guarantee accuracy of data, a sales-serialized median may be calculated based on a sales volume in one year followed by dividing the sales volume in the coming half month by this serialized median.

For example, assume the sales-serialized median of a certain merchandise is 51, the received short-term acceleration index is 1 if the sales volume in the half month is exactly 51, or the received short-term acceleration index is 2 if the sales volume of the half month is 102. It may be understood that the larger the short-term acceleration index is, the greater the sales volume of the product is.

In one embodiment, a region may correspond to one or more areas and an area may correspond to one or more smaller areas. In this embodiment the method may further comprise the steps of:

determining a proportion of a plurality of industries and categories between a designated area and the designated region, wherein the designated region includes the designated area;

calculating an area package volume based on the proportion and a preset area logistics proportion based on the overall future sales volume;

calculating a distribution route based on one or more smaller areas for distribution of distribution targets based on the area package volume, the one or more smaller areas included within the designated area;

calculating distribution time based on the distribution route;

calculating a future area package volume beyond preset distribution time based on the distribution time; and

calculating a future distribution coverage based on the area package volume beyond preset distribution time and the area package volume.

In one embodiment, for areas, proportions of various industries and categories in the areas and the region in which the areas belong may be received to convert a sales volume of the merchandise into a package volume of the region. With the overall future sales volume received via prediction, a future day package distribution volume of an area may be calculated according to the proportion of various industries and categories in the area and the region with the area, and the area logistics proportion of each area.

For the received future day package distribution volume of the area, an associated distribution route may be calculated according to a distribution address to which the merchandise is to be distributed, and the required distribution time is calculated further in combination with map data on the basis of the distribution route (the shortest time calculated according to the map data may be used as the distribution time, or error time produced due to some behaviors, such as package packing, may also be added).

Assuming that the distribution time should be less than 24 hours, failed package distribution may be determined if the required distribution time for the merchandise is more than 24 hours. Finally, the quantity of all failed package distributions, as well as the quantity of packages with failed distribution in the area within a certain period of time may be concluded statistically to calculate the distribution coverage, i.e., 24-hour delivery rate.

In one embodiment, the method may further comprise the steps of:

calculating a random distribution route; and

calculating an optimized distribution route based on a preset genetic algorithmic approach for the random distribution route.

In one embodiment, daily route optimization may be completed by using a genetic algorithm. For example, a merchandise distribution route may be initially randomized, followed by calculating the optimized distribution route using the genetic algorithm to increase distribution efficiency. Certainly, the distribution route may also be optimized by using an approach other than the genetic algorithm. The embodiment of the present disclosure does not need to be limited thereto.

In one embodiment, there are a plurality of the warehousing control centers, the method may further comprise the step of selecting the most recent failure point as the riskiest time from the failure points associated with the warehousing control centers, the warehousing control center associated with the riskiest time being considered as the riskiest warehousing control center.

In practice, a plurality of warehousing control centers may be deployed for larger regions or areas. As there may be a plurality of warehousing control centers, associated failure point may be calculated, respectively, wherein the most recent failure point may be used as the riskiest time, and the warehousing control center associated with the most recent failure point may be used as the riskiest warehousing control center.

In order for those skilled in the art to better understand the embodiment of the present disclosure, the present disclosure is described with the following specific example.

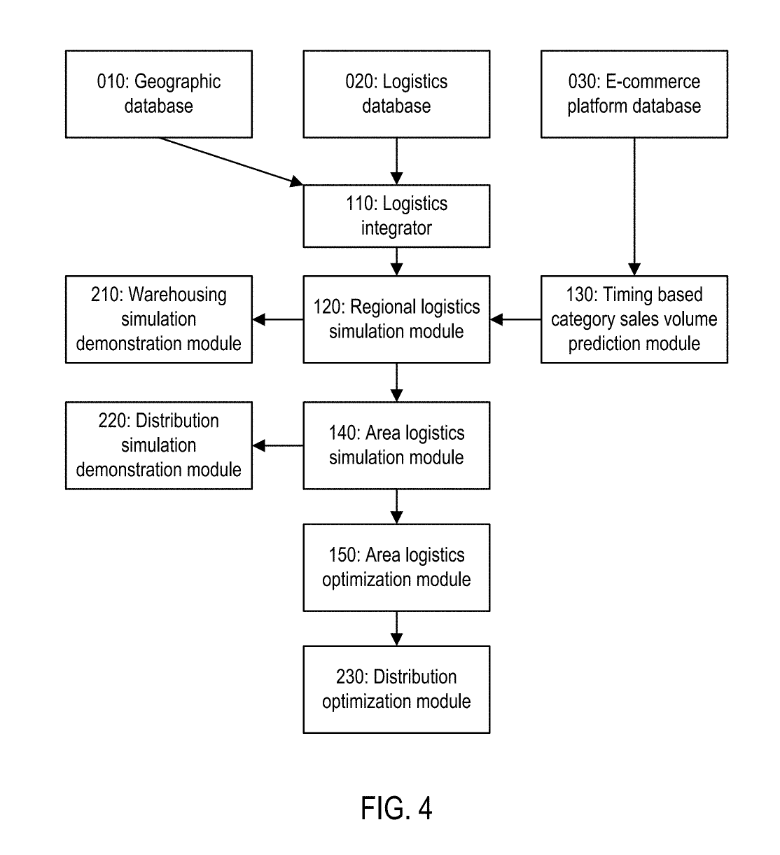

FIG. 4 is a block diagram of a system for determining effectiveness of warehousing according to some embodiments of the disclosure.

As illustrated in FIG. 4, the system includes an input subsystem comprising geographic database 010, logistics database 020, and e-commerce platform database 030. The system further includes a logistics subsystem comprising a logistics integrator 110 and a simulation subsystem comprising regional logistics simulation module 120, timing-based category sales volume prediction module 130, area logistics simulation module 140, and area logistics optimization module 150. The system may further include an output subsystem comprising warehousing simulation demonstration module 210, distribution simulation demonstration module 220, and distribution optimization module 230.

Input Subsystem

Geographic Database 010: The geographic database 010 may store traffic information of various regions, as well as various areas in the regions, and can be used in predicting distribution routes according to the traffic information. In some embodiments, information stored within geographic database 010 may be extracted from a complete geographic information database (not illustrated).

Logistics Database 020: Buyer-seller (merchant) merchandise is used as a composite key to record the logistics of the distributed merchandise, as well as distribution time and distribution address of the merchandise, in logistics database 020. In some embodiments, the distribution time may comprise start time of distribution and end time of distribution.

E-commerce platform database 030: The e-commerce platform database 030 may be provided or hosted by an e-commerce platform. The database may specifically maintain sales records of all merchandise on the e-commerce platform, including information with respect to both merchandise and sales times associated with the merchandise.

Logistics Subsystem

Logistics Integrator 110: The logistics integrator 110 is configured to integrate information with respect to both logistics of merchandise and merchandise in the e-commerce platform to obtain both logistics information and merchandise information. Integrated output of the logistics integrator may comprise a series of information, such as merchandise, merchant, merchant address, logistics company, distribution address, package weight, courier, and distribution time information.

Simulation Subsystem

Regional Logistics Simulation Module 120: based on the overall predicted sales volume received by the timing-based category sales volume prediction module 130 and proportions of various industries and categories in a region with respect to a general category for a region, the module 120 simulates tendencies of regional warehousing by means of the following specific steps:

Step 1: Proportions of various industries and categories with respect to a general category in each region (city level) are calculated for converting the sales volume into the quantity of logistics packages.

Step 2: A regional warehousing tendency is calculated to calculate a future day package volume based on the overall predicted sales volume, regional logistics proportion and proportions of various industries and categories with respect to a general category.

Timing-Based Category Sales Volume Prediction Module 130: This module 130 predicts sales trends of various industries according to different characteristics of sales changes for merchandise in different industries (and categories). The level of prediction granularity may be a day for industry and category. In one embodiment, the module 130 may perform the following steps.

Step 1: The tendency of a coming month in this year is reconstructed in light of the tendency of the corresponding days of the lunar calendar in the same month of last year (for example, a normalized sales tendency for the next month is fit on the basis of a sales volume in the last month of the lunar calendar in this year, as well as the tendency of the corresponding month and the following month of the lunar calendar in the last year). By example of August 1 of the lunar calendar in this year, the specific process may be illustrated as follows:

1. The sales volume of July in this year is divided by the sales volume of July in the last year to receive a ratio B.

2. A predicted sales volume of each day of August in this year is the sales volume of the corresponding lunar calendar day in the last year multiplied by the ratio B.

Step 2: Correction of tendency for a Gregorian calendar day: When a significant Gregorian calendar festival (e.g., National Day, New Year's Day etc.) exists in the prediction interval, an associated correction of the Gregorian calendar day vacation is performed (wherein the predicted sales volume within National Day is in logical consistency with Step 1, but the interval is changed from a lunar calendar day to the corresponding Gregorian calendar day, while there is no change for a non-significant festival, such as non-National Days).

Step 3: Generate focus indices for key industries and categories with acceleration. A short-term acceleration index is received by dividing the sales volume in the coming half month by the sales volume in the past one month or year. In one example, the median M of a sequence may be received based on normalization of sales volume of a certain year, followed by dividing sales volume of half month by M:

The result of receivable short-term acceleration is exemplified as follows:

[symbol] [0115] Overcoat: 2.5
Skirt: 0.7

[symbol]

The received short-term acceleration is sorted in descending order to receive a sorting result, according to which sales situations of various types of merchandises within a future short period may be determined very easily. For example, sales volumes of hairy crabs and moon cakes in the month that the Mid-Autumn Festival occurs will quickly increase, while those of octopuses and other merchandises tend to be stable.

Area Logistics Simulation Module 140: Based on the regional logistics simulation result output by module 120, this module calculates area-level results by means of the following steps in one embodiment.

Step 1: A proportion of various industries and categories with respect to a general category in each area (distribution unit, such as single delivery terminal) and region level is calculated for converting the sales volume of merchandises into the quantity of logistics packages.

Step 2: The warehousing tendency of the area is calculated, and the future day package volume of the area is calculated according to an area logistics proportion.

Step 3: Based on the future day package volume of the area in combination with geographic information of various small areas in the area, distribution routes of merchandise are calculated by using a map route calculation engine. For example, the route with the shortest time for distribution may be calculated in terms of distribution addresses of merchandises according to traffic information;

Step 4: Future packages are identified and assigned with a value to be marked as packages with failed distribution, the quantity of the packages with failed distribution in a certain time period is statistically concluded, based on which and in combination with the total package volume in this area, the distribution coverage of that area, i.e., the probability of successful distribution of that area, can be calculated.

Area Logistics Optimization Module 150: A genetic algorithm is utilized to accomplish daily distribution route optimization of merchandises. Specifically, a distribution route of a merchandise may be generated randomly at first, followed by optimizing the randomized distribution route using the genetic algorithm, and outputting an optimized distribution route solution.

Output Subsystem

Warehousing Simulation Demonstration 210: receives the output of module 120 and performs package volume simulation under different warehousing for various warehousing control centers, according to which the failure point and the riskiest time of the warehousing for the warehousing control center may be determined.

Distribution Simulation Demonstration 220: receives the output of module 14 and performs simulation for logistics statuses of each minimum distribution unit to determine distributed package volume and distribution coverage.

Distribution Optimization Solution 230: receives the output of module 150 to determine the optimized daily package distribution solution.

It is to be noted that a logistics simulator is the primary module in the system, while module 120 and module 140 are major functional modules that require the logistics simulator, all of which are described together herein.

The logistics simulator in the system may evaluate the warehousing of the warehousing control center effectively, that is, evaluate timeliness (24-hour delivery) and coverage (24-hour delivery rate) of current warehousing. There are two types of granularities for the evaluable warehousing, comprising regional granularity (e.g., division of a country into several regions (cities), each of which is covered by a different warehousing control center) and area-based granularity (e.g., division of Beijing into several areas, each of which is under charge of one warehousing control center).

Previously, the logistics simulator in the system did not exist on an existing system or platform for logistics monitoring, prediction and planning. There are currently no suitable methods for an existing logistics system to evaluate logistics or distribution solution, thus in the current state of the art the evaluation is mainly performed by logistics staffs based on experience. By incorporating a system and a platform for logistics monitoring, prediction and planning into the system, distribution of merchandise may be monitored, future sales volume of merchandises may be predicted, and warehousing may be planned in advance on the basis of future sales volume of products.

The logistics simulator in the system can be applied to evaluate the effectiveness and distribution coverage of the current warehousing of the warehousing control center very well. Certainly, the logistics simulator is not limited only to evaluation of the effectiveness and coverage of the current warehousing. Rather, it may predict and calculate the failure point of the distribution solution and the warehousing in the trend of current logistics development.

In one embodiment, the inputs to a logistics simulator may include warehousing information (comprising deployment location and associated actual transport capacity/quantity of warehousing control center), basic geographic information (traffic information), historic logistics information. Correspondingly, the outputs of the logistics simulator may include the effectiveness, distribution coverage and failure point of warehousing.

In one embodiment, the logistics simulator may perform the following steps.

Step 1: Historic logistics information is integrated into regional (module 120) or area-based (module 140) data set and a series of information, such as merchandise, merchant, merchant address, logistics company, distribution address, package weight, courier, distribution time may be obtained.

Step 2: A deployment point of a warehousing control center is combined with geographic information to calculate demanded transport quantity of logistics vehicles in each region (module 120) or distribution vehicles in each area (module 140) by daily booking data in the past one month.

Step 3: The demanded transport quantity of the logistics vehicles and the distribution vehicles in Step 2 is compared with an actual transport capacity/quantity, and it is indicated that the current warehousing can satisfy the current demand if the demanded transport quantity is equal to or smaller than the actual transport capacity/quantity.

Step 4: The failure point of the warehousing may be calculated further if the demanded transport quantity of the logistics vehicles and the distribution vehicles is equal to or smaller than the actual transport capacity/quantity. With respect to calculation logic, a most recent failure point is found out according to an output of a prediction module to act as an output for the failure point of the warehousing, according to which related staffs may perform planning in time.

According to the system described above, it may be understood that the following system, as well as modules in the system and associated functions of the modules are specifically proposed in one embodiment as follows:

(1) A system and platform of logistics appraisal and warehouse site selection on the basis of waybill simulation is proposed in one embodiment to accomplish an integrated simulation task for warehousing, site selection and distribution in a city, and offer optimization recommendation.

(2) For aspect (1), a single quantity prediction module on the basis of a multi-category timing model is disclosed, which may estimate city dimension warehousing demand in each of the coming years on the basis of logistics development to support development of warehousing service.

(3) For aspect (1), a logistics simulation module of small area granularity is introduced, which may accomplish estimation of logistics timeliness coverage after warehouse site selection.

(4) On the basis of (2) and (3), a distribution simulation module on the basis of traffic information history and prediction is proposed, which may accomplish evaluation of a distribution solution, and offer an optimized distribution solution.

In the embodiments of the present disclosure, in consideration of the fact that with growing popularity of online shopping, the number of waybills is increasing, even though the current warehousing can satisfy the demand of current product transport, it eventually will be unable to satisfy the demanded transport quantity. Therefore, when the current warehousing is determined to be effective, the failure point of the current warehousing will be calculated further, so that the warehousing planning can be improved in time in light of the failure point.

It is to be noted that method embodiments are expressed as combinations of a series of actions to simplify description. However, those skilled in the art should appreciate that the embodiments of the present disclosure are not limited to the order of the described actions because some steps may be performed in other orders or concurrently in accordance therewith. Next, those skilled in the art should appreciate that the embodiments described in the specification are all preferred embodiments, while the involved actions may not be necessary for the embodiments of the present disclosure.

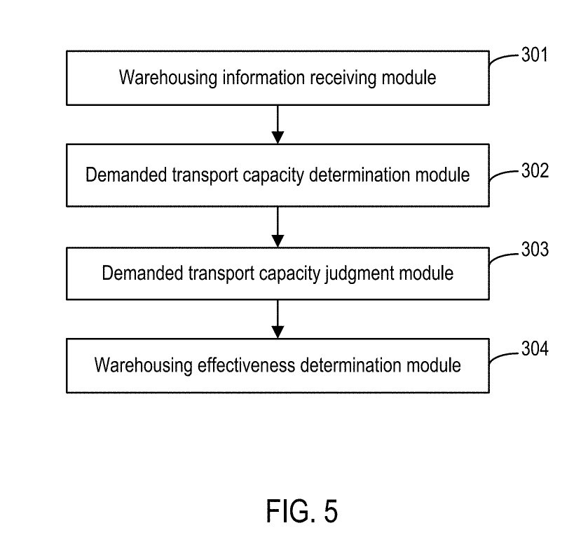

FIG. 5 is a block diagram of a system for determining effectiveness of warehousing according to some embodiments of the disclosure.

The system includes a warehousing information receiving module 301 for receiving warehousing information, wherein the warehousing information comprises a location and an actual transport capacity of a warehousing control center in the warehousing, as well as historic logistics information associated with the warehousing control center.

The system includes a demanded transport capacity determination module 302 for determining a demanded transport capacity of the warehousing control center based on the historic logistics information and the location of the warehousing control center.

In one embodiment, the demanded transport capacity determination module may include a historic logistics information receiving submodule, for extracting historic logistics information for a designated period of time in the past from the historic logistics information; and a demanded transport capacity calculation submodule, for calculating the demanded transport capacity of the warehousing control center based on the historic logistics information and the location of the warehousing control center.

The system includes a demanded transport capacity judgment module 303 for determining if the demanded transport capacity is equal to or smaller than the actual transport capacity and calling a warehousing effectiveness determination module 304 upon the determination that the demanded transport capacity is equal to or smaller than the actual transport capacity; and

The system includes a warehousing effectiveness determination module 304 for determining that the warehousing is effective.

In one embodiment, the system may further include a warehousing failure determination module for determining that the warehousing fails upon the determination that the demanded transport capacity is greater than the actual transport capacity.

In one embodiment, the warehousing information may include traffic information and sales records of an e-commerce platform. In this embodiment, the system may further include a failure point determination module for determining failure point of the warehousing based on the sales record and the traffic information.

In one embodiment, the sales records may include the times and volumes of sales targets. In this embodiment, the failure point determination module may further include:

an overall future sales volume submodule for predicting an overall future sales volume of the sales target at a designated time in the future based on the sales time and the sales volume of the sales target;

a proportion acquisition submodule for acquiring proportions of various industries and categories in a designated region with respect to a general category;

a regional package volume calculation submodule for calculating a regional package volume at the designated time in the future in light of the proportion and a preset regional logistics proportion based on the overall future sales volume;

a future demanded transport capacity calculation submodule for calculating a future demanded transport capacity of the warehousing center based on the regional future package volume; and

a future demanded transport capacity determination submodule for determining if the future demanded transport capacity is greater than the actual transport capacity and calling a failure point output submodule upon the determination that the future demanded transport capacity is greater than the actual transport capacity.

a failure point output submodule for determining the failure point based on the designated time in the future.

In one embodiment, the overall future sales volume submodule may include:

a first sales volumes receiving unit of various industries and categories for receiving, for the designated time in the future, sales volumes of various industries and categories in the month prior to the corresponding lunar month in this year, as well as sales volumes of various industries and categories in the month prior to the corresponding lunar month in the last year;

a first sales volumes comparison unit of various industries and categories for receiving a ratio by comparing the sales volumes of various industries and categories in the month prior to the corresponding lunar month in this year and the sales volumes of various industries and categories in the month prior to the corresponding lunar month in the last year;

a first future sales volumes calculation unit of various industries and categories for receiving future sales volumes of various industries and categories at the designated time in the future with the ratio and the time corresponding to the designated time in the future in the last year;

a first overall future sales volume calculation unit for acquiring an overall future sales volume based on the future sales volumes of various industries and categories.

In one embodiment, the overall future sales volume submodule may include:

a second sales volumes receiving unit of various industries and categories for receiving, for the designated time in the future, sales volumes of various industries and categories in the month prior to the corresponding Gregorian calendar month in this year, as well as sales volumes of various industries and categories in the month prior to the corresponding Gregorian calendar month in the last year;

a second sales volumes comparison unit of various industries and categories for receiving a ratio by comparing the sales volumes of various industries and categories in the month prior to the corresponding Gregorian calendar month in this year and the sales volumes of various industries and categories in the month prior to the corresponding Gregorian calendar month in the last year;

a second future sales volumes calculation unit of various industries and categories for receiving future sales volumes of various industries and categories at the designated time in the future with the ratio and the time corresponding to the designated time in the future in the last year; and

a second overall future sales volume calculation unit for acquiring an overall future sales volume based on the future sales volumes of various industries and categories.

In one embodiment, the system may include: a future sales volume receiving module for receiving future sales volumes of various industries and categories for a preset future time period; and a short-term acceleration index calculation module for calculating a short-term acceleration index based on the future sales volumes of various industries and categories and the median of the sequence of the sales volumes.

In one embodiment, the region may include one or more areas and an area may include one or more small areas. In this embodiment, the system may further include:

a proportion determination module for determining a proportion of various industries and categories between a designated area and the designated region;

an area package volume calculation module for calculating an area package volume in light of the proportion and a preset area logistics proportion based on the overall future sales volume;

a distribution route calculation module for calculating a distribution route in light of small areas for distribution of distribution targets based on the area package volume;

a distribution time calculation module for calculating distribution time based on the distribution route;

a package beyond distribution time determination module for determining an area package volume beyond preset distribution time based on the distribution time; and

a future distribution coverage calculation module for calculating a future distribution coverage based on the area package volume beyond preset distribution time and the area package volume.

In one embodiment, the system may further include a random distribution route determination module for determining a random distribution route; and a distribution route optimization module for calculating an optimized distribution route based on a preset genetic algorithmic approach for the random distribution route.

In one embodiment, there may be a plurality of the warehousing control centers. In this embodiment, the system may further include a riskiest point calculation module for selecting the most recent failure point as the riskiest time from the failure points associated with the warehousing control centers, the warehousing control center associated with the riskiest time being considered as the riskiest warehousing control center.

In one embodiment, the system may further include:

a package information receiving module for receiving a past package volume and distribution time associated with package for a designated period of time in the past;

a package volume determination module for determining a past package volume beyond preset distribution time based on the distribution time; and

a distribution coverage calculation module for calculating a distribution coverage based on the past package volume beyond preset distribution time and the area package volume.

In some embodiments, the system may perform the methods described in connection with FIGS. 1-4 and descriptions of the methods may be referenced for related portions appearing in FIG. 5.

Various embodiments in the specification are all described in a progressive manner. The key point of each embodiment is described with respect to difference from other embodiments. The same or similar portions of different embodiments may be referenced with each other.

Those skilled in the art should understand that an embodiment in the embodiments of the present disclosure may be provided as a method, an apparatus, or a computer program product. Therefore, an embodiment of the present disclosure may be in the form of a full hardware embodiment, a full software embodiment, or a combination thereof. Moreover, an embodiment of the present disclosure may be in the form of a computer program product implemented on one or more computer usable storage media (including, but not limited to, disk memory, CD-ROM, optical memory etc.) containing computer usable program codes therein.

In a typical configuration, the computer device comprises one or more processors (CPUs), input/output interfaces, networking interface and memory. The memory may comprise computer readable medium in the form of non-permanent memory, random access memory (RAM) and/or non-volatile memory or the like, such as read-only memory (ROM) or flash memory (Flash RAM). The memory is an example of computer readable medium. The computer-readable medium includes permanent and non-permanent, movable and non-movable media that can achieve information storage by means of any methods or techniques. The information may be computer-readable instructions, data structures, modules of programs or other data. Examples of storage medium of computer include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disk (DVD) or other optical storages, magnetic cassette, magnetic tape, magnetic disk storage or other magnetic storage devices, or any other non-transmission medium than can be used for storing the information accessible by a computing device. In light of the definitions herein, the computer readable medium does not include non-persistent computer readable media (transitory media), such as modulated data signals and carrier waves.

The embodiments of the present disclosure are described with reference to flow diagrams and/or block diagrams of methods, terminal devices (systems), and computer program products according thereto. It should be understood that computer program instructions may be used to implement each flow and/or block in the flow diagrams and/or block diagrams, and a combination of flows and/or blocks in the flow diagrams and/or block diagrams. These computer program instructions may be provided to a processor of a general-purpose computer, a special-purpose computer, an embedded processor, or other programmable data processing terminal device to produce one machine, such that the instructions executed by the computer or the processor of other programmable data processing terminal device produce an apparatus for implementing functions designated in one or more flows in flow diagrams and/or one or more blocks in block diagrams.

These computer program instructions may also be stored in a computer readable memory capable of guiding the computer or other programmable data processing terminal device to operate in a particular manner, such that the instructions stored in the computer readable memory produce an article of manufacture comprising an instruction apparatus. The instruction apparatus implements the functions designated in one or more flows of flow diagrams and/or one or more blocks in block diagrams.

These computer program instructions may also be loaded onto a computer or other programmable data processing terminal device, such that a series of operation steps executed on the computer or other programmable terminal device produce a process implemented by the computer. Accordingly, the instructions executed on the computer or other programmable terminal device provide steps for implementing the functions designated in one or more flows in flow diagrams and/or one or more blocks in block diagrams.

While preferred embodiments are described for the embodiments of the present disclosure, those skilled in the art may additionally alter and modify these embodiments upon knowing the basic creative concept. Thus, the attached claims are intended to be construed as comprising the preferred embodiments and all alternations and modifications within the embodiments of the present disclosure.

Finally, it is to be further noted herein that relational terms, such as first and second, are only used to discriminate one entity or operation from another entity or operation, rather than to request or imply that any such actual relationship or order exists between these entities or operations. Moreover, terms “comprise”, “include” or any other variant thereof is intended to cover non-exclusive inclusion, such that a process, method, article or terminal device comprising a series of elements may comprise not only those elements, but also other elements not listed explicitly, or further comprises elements inherent to such process, method, article or terminal device. Without further limitation, elements limited by statement “comprise one” do not exclude existence of an additional identical element in the process, method, article or terminal device comprising the elements.

A method of determining effectiveness of warehousing and an apparatus of determining effectiveness of warehousing provided in the present disclosure is presented in detail above. The principle and implementation approach of the present disclosure are explained with specific examples. Description of the above embodiments is only to assist in understanding the method of the present disclosure and the core idea thereof. Also, variations of specific implementation and application scope are possible for those skilled in the art in accordance with the idea of the present disclosure. In summary, the content of the specification shall not be construed as limitation to the present disclosure.

What is claimed is:

1. A method comprising:
receiving warehousing information, the warehousing information including a location and an actual transport capacity of a warehousing control center and historic logistics information associated with the warehousing control center;
calculating a demanded transport capacity of the warehousing control center based on the historic logistics information and the location of the warehousing control center;
determining that the warehousing is effective if the demanded transport capacity is equal to or less than the actual transport capacity; and
determining that the warehousing is ineffective if the demanded transport capacity is greater than the actual transport capacity.

2. The method of claim 1, wherein calculating a demanded transport capacity of the warehousing control center based on the historic logistics information and the location of the warehousing control center comprises:
extracting past historic logistics information from the historic logistics information, the past historic logistics information representing a portion of the historic logistics information for a designated period of time in the past; and
calculating the demanded transport capacity of the warehousing control center based on the past historic logistics information and the location of the warehousing control center.

3. The method of claim 1, wherein the warehousing information further includes traffic information and a sales record, and wherein the method further comprises determining a failure point of the warehousing based on the sales record and the traffic information, wherein the failure point represents a point in time when a future demanded transport capacity will exceed actual transport capacity.

4. The method of claim 3, wherein the sales record includes a sales time and a sales volume of a sales target, and wherein determining a failure point of the warehousing comprises:
predicting an overall future sales volume of the sales target;
determining the proportions of a first plurality of industries and categories in a region with a second plurality of industries and categories without the region;
calculating a regional future package volume at the future point in time based on the proportions and the overall future sales volume;
calculating the future demanded transport capacity of the warehousing control center based on the regional future package volume;
determining if the future demanded transport capacity is greater than the actual transport capacity; and
determining the failure point based on a designated time in the future that it is determined that the future demanded transport capacity will exceed the actual transport capacity.

5. The method of claim 4, wherein calculating future sales volumes comprises:
receiving sales volumes of the plurality of industries and categories in a month prior to the corresponding Gregorian calendar month of a current Gregorian calendar year;
receiving sales volumes of the plurality of industries and categories in a month prior to the corresponding Gregorian calendar month in a year preceding the current year;
calculating a ratio between the sales volumes of the plurality of industries and categories in a month prior to the corresponding Gregorian calendar month of a current Gregorian calendar year and sales volumes of the plurality of industries and categories in a month prior to the corresponding Gregorian calendar month in a year preceding the current year;
calculating future sales volumes of the plurality of industries and categories at a future point in time based on the ratio and a point in time of the preceding year corresponding to the future point in time; and
determining an overall future sales volume based on the future sales volumes of the plurality of industries and categories.

6. The method of claim 4, further comprising:
receiving future sales volumes of a plurality of industries and categories for a preset future time period; and
calculating a short-term acceleration index based on the future sales volumes and the median of the sales volumes.

7. The method of claim 1 further comprising:
determining a proportion of a plurality of industries and categories between an area and a region including the area;
calculating a current area package volume based on the proportion and a preset area logistics proportion, the preset area logistics proportion being based on the overall future sales volume;
calculating a distribution route based on one or more smaller areas for distribution of distribution targets based on the current area package volume, the one or more smaller areas included within the area;
calculating a distribution time based on the distribution route;
calculating a future area package volume based on the distribution time; and
calculating a future distribution coverage based on the future area package volume and the current area package volume.

8. The method of claim 7, further comprising:
calculating a random distribution route; and
calculating an optimized distribution route based on a preset genetic algorithmic.

9. The method of claim 1, further comprising:
selecting a most recent failure time as a riskiest time from failure times associated with one or more warehousing control centers, the warehousing control center associated with the riskiest time considered as the riskiest warehousing control center.

10. A system comprising:
a warehousing information receiving module for receiving warehousing information, the warehousing information including a location and an actual transport capacity of a warehousing control center and historic logistics information associated with the warehousing control center;
a demanded transport capacity determination module for calculating a demanded transport capacity of the warehousing control center based on the historic logistics information and the location of the warehousing control center;
a demanded transport capacity judgment module for determining if the demanded transport capacity is equal to or less than the actual transport capacity; and
a warehousing effectiveness determination module for determining that the warehousing is effective upon the determination that the demanded transport capacity is equal to or less than the actual transport capacity.

11. The system of claim 10, wherein the demanded transport capacity determination module comprises:
a historic logistics information receiving submodule for extracting past historic logistics information from the historic logistics information, the past historic logistics information representing a portion of the historic logistics information for a designated period of time in the past; and
a demanded transport capacity calculation submodule for calculating the demanded transport capacity of the warehousing control center based on the past historic logistics information and the location of the warehousing control center.

12. The system of claim 10, wherein the warehousing information further includes traffic information and a sales record, and wherein the system further comprises a failure point determination module for determining a failure point of the warehousing based on the sales record and the traffic information, wherein the failure point represents a point in time when a future demanded transport capacity will exceed actual transport capacity.

13. The system of claim 12, wherein the sales record includes a sales time and a sales volume of a sales target, and wherein the failure point determination module comprises:
an overall future sales volume submodule for predicting an overall future sales volume of the sales target;
a relational proportion acquisition submodule for determining the proportions of a first plurality of industries and categories in a region with a second plurality of industries and categories without the region;
a regional package volume calculation submodule for calculating a regional future package volume at the future point in time based on the proportions and the overall future sales volume;
a future demanded transport capacity calculation submodule for calculating the future demanded transport capacity of the warehousing control center based on the regional future package volume;
a future demanded transport capacity determination submodule for determining if the future demanded transport capacity is greater than the actual transport capacity; and
a failure point output submodule for determining the failure point based on a designated time in the future that it is determined that the future demanded transport capacity will exceed the actual transport capacity.

14. The system of claim 13, wherein the overall future sales volume submodule comprises:
a second sales volumes receiving unit for receiving sales volumes of the plurality of industries and categories in a month prior to the corresponding Gregorian calendar month of a current Gregorian calendar year and receiving sales volumes of the plurality of industries and categories in a month prior to the corresponding Gregorian calendar month in a year preceding the current year;
a second sales volumes comparison unit for calculating a ratio between the sales volumes of the plurality of industries and categories in a month prior to the corresponding Gregorian calendar month of a current Gregorian calendar year and sales volumes of the plurality of industries and categories in a month prior to the corresponding Gregorian calendar month in a year preceding the current year;
a second future sales volumes calculation unit for calculating future sales volumes of the plurality of industries and categories at a future point in time based on the ratio and a point in time of the preceding year corresponding to the future point in time; and
a second overall future sales volume calculation unit for determining an overall future sales volume based on the future sales volumes of the plurality of industries and categories.

15. The system of claim 13, further comprising:
a future sales volume receiving module for receiving future sales volumes of a plurality of industries and categories for a preset future time period; and
a short-term acceleration index calculation module for calculating a short-term acceleration index based on the future sales volumes and the median of the sales volumes.

16. The system of claim 10, further comprising:
a relational proportion determination module for determining a proportion of a plurality of industries and categories between an area and a region including the area;
an area package volume calculation module for calculating a current area package volume based on the proportion and a preset area logistics proportion, the preset area logistics proportion being based on the overall future sales volume;
a distribution route calculation module for calculating a distribution route based on one or more smaller areas for distribution of distribution targets based on the current area package volume, the one or more smaller areas included within the area;
a distribution time calculation module for calculating a distribution time based on the distribution route;
a package beyond distribution time determination module for calculating a future area package volume based on the distribution time; and
a future distribution coverage calculation module for calculating a future distribution coverage based on the future area package volume and the current area package volume.

17. The system of claim 16, further comprising:
a random distribution route determination module for calculating a random distribution route;
a distribution route optimization module for calculating an optimized distribution route based on a preset genetic algorithmic.

18. The system of claim 10, further comprising:
a riskiest point calculation module for selecting a most recent failure time as a riskiest time from failure times associated with one or more warehousing control centers, the warehousing control center associated with the riskiest time considered as the riskiest warehousing control center.
